(19) United States
(12) Patent Application Publication
(10) Pub. No.: US 2009/0142553 A1
(43) Pub. Date: Jun. 4, 2009

(54) Yellow Dye and a Process for Ink Jet Printing Using the Dye

(76) Inventors: Gavin Wright, Manchester (GB); Roy Bradbury, Merseyside (GB); Lynn Patricia Bradbury, Merseyside (GB)

Correspondence Address: MORGAN LEWIS & BOCKIUS LLP, 1111 PENNSYLVANIA AVENUE NW, WASHINGTON, DC, 20004, US

(21) Appl. No.: 11/992,960

(22) PCT Filed: Oct. 4, 2006
(86) PCT No.: PCT/GB2006/003684

§ 371 Date: Apr. 2, 2008

(30) Foreign Application Priority Data
Oct. 13, 2005 (GB) 0520833.5

(51) Int. Cl. C09B 29/042; B05D 5/06; C09D 11/02; B32B 3/00

(52) U.S. Cl. 428/195.1; 427/256; 534/753; 106/31.48

(57) ABSTRACT

A process for printing an image on a substrate comprising applying thereto by means of an ink jet printer an ink comprising a compound of Formula (1):

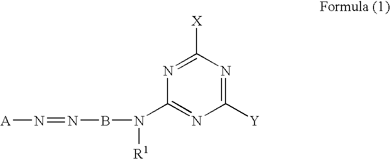

wherein one of A and B is an optionally substituted heteroaryl group containing a ring sulphur atom and the other is an optionally substituted aryl or heteroaryl group and R¹, X and Y are as specified. Also claimed are compounds of Formula (1) and various compositions containing the same.

This invention relates to compounds suitable for use as dyes, to inks and to their use in ink jet printing (“IJP”). IJP is a non-impact printing technique in which droplets of ink are ejected through a fine nozzle onto a substrate without bringing the nozzle into contact with the substrate.

There are many demanding performance requirements for dyes and inks used in IJP. For example they desirably provide sharp, non-feathered images having good water-fastness, light-fastness and optical density. The inks are often required to dry quickly when applied to a substrate to prevent smudging, but they should not form a crust over the tip of an ink jet nozzle because this will stop the printer from working. The inks should also be stable to storage over time without decomposing or forming a precipitate that could block the fine nozzle.

JP 11209643 describes yellow dye blends and their use in the coloration of cellulose fibres.

It has now surprisingly been found that certain yellow compounds provide valuable colorants for ink jet printing inks.

According to a first aspect of the present invention there is provided a process for printing an image on a substrate comprising applying to the substrate by means of an ink jet printer an ink comprising a compound of Formula (1):

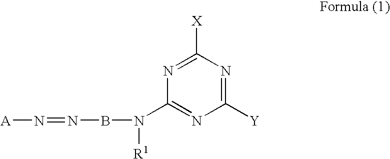

wherein:
one of A and B is an optionally substituted heteroaryl group containing a ring sulphur atom and the other is an optionally substituted aryl or heteroaryl group;
R¹ is H, optionally substituted acyl or optionally substituted alkyl;
X is a hydroxyl, ether, thioether or amine group; and
Y is a hydroxyl, ether, thioether or amine group or a group of the formula —N(R²)-D-N═N-E wherein D and E are each independently optionally substituted aryl or heteroaryl groups and R² is H, optionally substituted acyl or optionally substituted alkyl.

Preferably the compound of Formula (1) is water-soluble.

Preferably the compound of Formula (1) has at least as many sulpho groups as the total number of groups selected from carboxy (e.g. —COOH) and thiocarboxy (e.g. —COSH) groups. In one embodiment the compound of Formula (I) is free from carboxy and thiocarboxy groups.

Preferably Y is a hydroxyl, ether, thioether or amine group or a group of the formula —N(R²)-D-N═N-E wherein D and E are each independently optionally substituted aryl or heteroaryl groups and R² is H or optionally substituted alkyl.

Preferably Y is a group of the formula —N(R²)-D-N═N-E wherein R², D and E are as hereinbefore defined.

In one embodiment A is an optionally substituted heteroaryl group containing a ring sulphur atom and B, D and E are each independently optionally substituted aryl or heteroaryl groups.

In another embodiment A is an optionally substituted heteroaryl group containing a ring sulphur atom, E is an optionally substituted heteroaryl group and B and D are each independently optionally substituted aryl or heteroaryl groups.

In another embodiment A is an optionally substituted heteroaryl group containing a ring sulphur atom, E is an optionally substituted heteroaryl group and B and D are each independently optionally substituted aryl groups.

Preferably A and E are each independently optionally substituted heteroaryl groups containing a ring sulphur atom.

Preferably A and E are free from hydroxy groups. Preferably the triazine group shown in Formula (1) is attached to the nitrogen which is directly attached to the ring of the optionally substituted aryl or heteroaryl groups represented by B and D.

Preferred optionally substituted aryl groups are optionally substituted phenyl and optionally substituted naphthyl.

Preferred optionally substituted heteroaryl groups are optionally substituted pyrrole, furan, thiophene, benzothiophene, pyrazole, imidazole, triazole, thiazole, benzothiazole, isothiazole, benzoisothiazole, thiadiazole, pyridine, pyrimidine or pyrazine groups.

Preferred optionally substituted heteroaryl groups containing a ring sulphur atom include optionally substituted thiophene, benzothiophene, thiazole, benzothiazole, isothiazole, benzoisothiazole, thiadiazole and naphthothiazole.

Examples of suitable amines from which the optionally substituted heteroaryl group containing a ring sulphur atom may be derived include 2-aminobenzothiazole, 2-amino-6-methylsulfonylbenzothiazole, 2-amino-6-nitrobenzothiazole, 5,6-dichloro-2-aminobenzothiazole, 6,7-dichloro-2-aminobenzothiazole, 4-amino-5-bromo-7-nitro-1,2-benzoisothiazole, 3-amino-5-nitro-2,1-benzoisothiazole, 3-amino-5-nitro-7-bromo-2,1-benzoisothiazole, 2-aminothiazole, 2-amino-5-nitrothiazole, the ethyl ester of 2-amino-4-methylthiazole-5-carboxylic acid, 2-amino-4-methyl-5-acetylthiazole, 2-amino-3-cyano-4-methylthiophene-5-carboxylic esters, 2-phenyl-5-amino-1,3,4-thiadiazole, 3-methylmercapto-5-amino-1,2,4-thiadiazole, 3-beta-carbomethoxyethylmercapto-5-amino-1,2,4-thiadiazole, 2-amino-4,5-dimethylthiazole*, 2-amino-5-ethenyl-4-methylthiazole*, 2-amino-5-ethinyl-4-methylthiazole*, 2-amino-4-methyl-5-phenylthiazole*, 2-amino-4-methyl-5-(phenylmethyl)thiazole*, 2-amino-4-methyl-5-sulfothiazole, 2-amino-4-methyl-5-nitrothiazole and 2-amino-5-hydroxy-4-methylthiazole. *May be prepared according to the methods of Tartell, et al., J. Amer. Chem. Soc., 72, 3138 (1950), or Byers, et al., Org. Syn. Coll. Vol. 3, 332 (1955), or modifications thereof.

The optional substituents which may be present on A, B, D and E are preferably each independently selected from C₁₋₈-alkyl, C₁₋₈-alkoxy, NR³R⁴, NHCOR³, NHCONR³R⁴, —C(O)R³, —C(O)OR³, —C(O)NR³R⁴, PO₃H₂, —SR³, —SO₂R³, —SO₂NR³R⁴, —SOR³, —SO₃H, CF₃, CN, NO₂ and halogen, wherein R³ and R⁴ are each independently H, C-4-alkyl or C₁₋₄-alkyl carrying a hydroxyl, carboxy or sulpho group, or R³ and R⁴ together with the nitrogen atom to which they are attached form an optionally substituted 5- or 6-membered ring.

Preferably the compound of Formula (1) has at least 1 sulpho group, more preferably from 2 to 5 sulpho groups.

Preferred optionally substituted acyl groups are of the formula —CO—R⁵ wherein R⁵ is an optionally substituted alkyl or aryl group.

Preferred ether groups are of the formula —O—R⁵ wherein R⁵ is an optionally substituted alkyl or aryl group.

Preferred thioether groups are of the formula —S—R⁵ wherein R⁵ is an optionally substituted alkyl or aryl group.

Preferred amine groups are of the formula —NR³R⁴ wherein each R³ and R⁴ independently is as hereinbefore defined.

Preferred optionally substituted alkyl groups are optionally substituted C₁₋₈-alkyl, more preferably C₁₋₄-alkyl, for example methyl, ethyl, propyl, isopropyl, butyl, sec-butyl, optionally substituted by for example hydroxy, halogen, carboxy or sulpho groups. Examples include trifluoromethyl, hydroxyethyl, sulphopropyl and carboxyethyl.

Preferably R¹ is H or optionally substituted alkyl.

Preferably R¹ and R² are each independently H or C-4-alkyl, more preferably H.

Preferred optionally substituted 5- or 6-membered rings include, thiophene, pyrazole, imidazole, triazole, thiazole, thiadiazole and pyridine rings.

Preferred optionally substituted aryl groups are optionally substituted phenyl and optionally substituted naphthyl. Preferred optional substituents include C₁₋₈-alkyl, C₁₋₈-alkoxy, NR³R⁴, NHCOR³, NHCONR³R⁴, —C(O)R³, —C(O)OR³, —C(O)NR³R⁴, PO₃H₂, —SR³, —SO₂R³, —SO₂NR³R⁴, —SOR³, —SO₃H, CF₃, CN, NO₂ and halogen, wherein R¹ and R² are as hereinbefore defined.

It is especially preferred that the compounds of Formula (1) are yellow or orange in colour. The compounds of the present invention exhibit particularly good ozone fastness, light fastness and optical density, making them valuable colourants for photorealistic and other ink jet printing applications providing bright yellow ink jet prints.

The compounds of Formula (1) preferably also have good solubility in an ink jet printing ink and good operability in ink jet printers. Inks comprising water-soluble compounds of Formula (1) demonstrate a low tendency to crust over or block nozzles when printed from an ink jet printer.

Compounds of Formula (1) are preferably free from fibre reactive groups because no such groups are required. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye.

The compounds of Formula (1) are suitable for use as dyes for ink jet printing and may be prepared by, for example, by condensing a compound of formula H—X and a compound of formula H—Y (wherein X and Y are as hereinbefore defined) with a compound of Formula (1) except that in place of X and Y there are labile halogen atoms. Preferably the condensation is performed in alkali solution utilising sodium or lithium hydroxide as the base at 60-80° C. for 4-10 hours.

The intermediate compounds of Formula (1) wherein X is chloro may be prepared by, for example, the condensation of 1 mole of an amine of formula A-N═N—B—NH₂ and 1 mole of an amine of formula E-N═N-D-NH₂ with 1 mole of cyanuric chloride. Alternatively, to achieve a symmetrical molecule, 2 moles of the amine of A-N═N—B—NH₂ may be condensed with 1 mole of cyanuric chloride (wherein A, B, D, E and X are as hereinbefore defined). The condensation is preferably performed in aqueous solution at 0 to 40° C. and pH 5 to 7.

The compounds of Formula (1) may be in the free acid or salt form. Preferred salts are water-soluble, for example alkali metal salts, (especially lithium, sodium, potassium), ammonium, substituted ammonium and mixed salts thereof. Preferred metal salts are those with sodium, lithium, ammonium and substituted alkyl ammonium salts.

Preferred ammonium and substituted alkyl ammonium salts have cations of the formula ⁺NV₄ wherein each V independently is H or optionally substituted alkyl, or two groups represented by V are H or optionally substituted alkyl and the remaining two groups represented by V, together with the N atom to which they are attached, form a 5- or 6-membered ring

Preferably each V independently is H or C₁₋₄-alkyl, more preferably H, CH₃ or CH₂CH₃, especially H.

Preferred cyclic cations comprise a morpholinyl, pyridinyl pr piperidinyl ring.

Examples of cations include ⁺NH₄, morpholinium, piperidinium, pyridinium, (CH₃)₃N⁺H, (CH₃)₂N⁺H₂, H₂N⁺(CH₃)(CH₂CH₃), CH₃N⁺H₃, CH₃CH₂N⁺H₃, H₂N⁺(CH₂CH₃)₂, CH₃CH₂CH₂N⁺H₃, (CH₃)₂CHN⁺H₃, N⁺(CH₃)₄, N⁺(CH₂CH₃)₄, N-methylpyridinium, N,N-dimethyl piperidinium and N,N-dimethyl morpholinium.

It is especially preferred that the compounds of Formula (1) according to the present inventions are in the form of a sodium, lithium, potassium, ammonium, substituted ammonium salt or mixtures thereof.

The compounds of Formula (1) may be converted into a salt using known techniques. For example, an alkali metal salt of a compound may be converted into a salt with ammonia or an amine by dissolving an alkali metal salt of the compound in water acidifying with a mineral acid and collecting the precipitated free acid by filtration. The isolated solid is then dissolved in water and the pH of the solution adjusted to pH 9 to 9.5 with ammonia or the amine and removing the alkali metal cations by dialysis. Alternatively, the desired salt form may be prepared by dissolving an alkali metal salt of the compound of Formula (1) in water and passing the solution through a column of a suitably modified ion exchange resin.

The compounds of Formula (1) are preferably dyes, more preferably water-soluble dyes.

The compounds of Formula (1) may exist in tautomeric forms other than those shown in this specification. These tautomers are also included within the scope of the present invention.

According to a second aspect of the present invention there is provided a compound of Formula (1). The preferences for the compound of Formula (1) are as hereinbefore described in relation to the first aspect of the present invention.

The compounds of Formula (1) exist in tautomeric forms other than those shown in this specification and such tautomeric forms are included within the scope of the formulae as drawn herein.

The compounds of Formula (1) may be used as the sole colorant in inks because of their attractive yellow or orange shade. However, if desired, one may combine the present compounds with one or more further colorants if a slightly different shade is required for a particular end use. The further colorants are preferably dyes. When further colorants are included in the ink these are preferably selected from yellow, magenta, cyan and black colorants and combinations thereof, most preferably yellow or magenta colorants and combinations thereof.

According to a third aspect of the present invention there is provided a composition comprising;
a) two or more compounds of Formula (1); or
b) one or more compounds of Formula (1) and one or more colorants other than a compound of Formula (1).

Preferably the compound of Formula (1) present in the composition is as defined in the second aspect of the present invention.

Preferably the composition according to the third aspect of the present invention is mixed so as to provide a uniform colour.

The colorant other than a compound of Formula (1) (hereinafter referred to as “further colorant”) may be a pigment or a dye.

Suitable further colorants are listed in the Colour Index International.

The amounts of the compound and further colorant(s) present in the composition according to the third aspect of the present invention may be selected so as to adjust the shade or other properties as desired.

Preferred further colorants include yellow, magenta, cyan and black pigments and yellow, magenta, cyan and black dyes.

Suitable further colorants include, for example, yellow pigments, for example, C.I. Pigment Yellow 55, 74, 93, 109, 110, 128, 138, 150, 151, 154, 155, 180 and 185; yellow dyes, for example, C.I. Acid Yellow 17, 19, 23, 25, 32, 40, 42, 44, 49, 61, 127, 151, 199, 219; C.I. Direct Yellow 8, 11, 12, 27, 28, 29, 44, 50, 85, 86, 96, 100, 106, 132, 142, 144, 173, the yellow dyes disclosed in granted U.S. Pat. Nos. 6,320,031, 6,068,687, US patent application publication No 2004-068102 (especially example 1 at [0157]), PCT application publication Nos WO2005-160937 (especially examples Yellow R1 and R2 at [0028] and [0029]), WO2005-007752 (especially example 1 at [0024]) and WO2002-075573 and salts thereof; magenta pigments, for example C.I. Pigment Red 122, 202, 209 and C.I. Pigment Violet 19; magenta dyes, for example PRO-JET™ Fast Magenta 2, PRO-JET™ Magenta BTX, 3BOA, 2BTX and 1T; C.I. Acid Red 52 and 249; C.I. Reactive Red 180, 31 and 23; and C.I. Direct Red 227; cyan pigments, for example C.I. Pigment Blue 15, 15:1, 15:2, 15:3, 15:4, 15:6, 16 and 60; cyan dyes, for example phthalocyanine colorants, especially C.I. Direct Blue 86, 199 and C.I. Acid Blue 9, 99; black pigments, for example C.I. Pigment Black 7 and the self-dispersing black pigments sold under the Cab-O-Jet™ trade name by Cabot Corp (e.g. Cab-O-Jet 300); and black dyes, for example C.I. Food Black 2, C.I. Direct Black 19, 154, 168, 195, C.I. Reactive Black 31, PRO-JET™ Fast Black 2 and black dyes described in patents by Lexmark (for example EP 0 539,178 A2, examples 1, 2, 3, 4 and 5), Orient Chemicals (for example EP 0 347 803 A2, pages 5 to 6, azo dyes 3, 4, 5, 6, 7, 8, 12, 13, 14, 15 and 16) and Seiko Epson Corporation.

It is preferred that the one or more colorants other than a compound of Formula (1) for use in the composition according to the third aspect of the invention comprise a water-soluble dye.

The composition according to the third aspect of the present invention preferably comprises:
(a) from 1 to 99, more preferably from 3 to 70 and especially from 5 to 50 parts in total of the compound(s) of Formula (I); and
(b) from 99 to 1, more preferably from 30 to 97 parts and especially 95 to 50 parts in total of a water-soluble dye(s) other than a compound of Formula (1);
   wherein the parts are by weight and the sum of the parts (a)+(b)=100.

The composition may contain a single compound of Formula (1) or a mixture thereof. Similarly, the composition may contain in (b) a single water-soluble dye or a mixture of two or more water-soluble dyes other than a compound of Formula (1).

The compounds and compositions according to the second and third aspects of the present invention may be, and preferably are, purified to remove undesirable impurities before they are incorporated into inks for ink jet printing. Conventional techniques may be employed for purification, for example ultrafiltration, reverse osmosis and/or dialysis.

According to a fourth aspect of the present invention there is provided an ink for ink jet printing comprising:
(a) a compound of Formula (1) or a salt thereof, or a composition according to the third aspect of the invention; and
(b) a liquid medium.

Preferably the compound of Formula (1) present in the ink is as defined in the second aspect of the present invention.

The liquid medium preferably comprises:
(i) water; or
(ii) a mixture of water and an organic solvent.

A preferred ink according to the fourth aspect of the present invention comprises:
(a) from 0.01 to 30 parts of a compound of Formula (I) or salt; and
(b) from 70 to 99.99 parts of a liquid medium;
   wherein the liquid medium comprises an organic solvent, the parts are by weight and the number of parts of (a) and (b)=100.

The number of parts by weight of component (a) is preferably from 0.01 to 30, more preferably 0.1 to 20, especially from 0.5 to 15, and more especially from 1 to 5 parts. The number of parts by weight of component (b) is preferably from 99.99 to 70, more preferably from 99.9 to 80, especially from 99.5 to 85, and more especially from 99 to 95 parts. The number of parts (a)+(b) is 100 and all parts mentioned here are by weight.

Preferably component (a) is completely dissolved in component (b). Preferably component (a) has a solubility in component (b) at 20° C. of at least 10% by weight. This allows the preparation of liquid dye concentrates which may be used to prepare more dilute inks and reduces the chance of the compound(s) of component (a) of the ink precipitating if evaporation of the liquid medium occurs during storage.

When the medium comprises a mixture of water and an organic solvent, the weight ratio of water to organic solvent is preferably from 99:1 to 1:99, more preferably from 99:1 to 50:50 and especially from 95:5 to 80:20.

It is preferred that the organic solvent is a water-miscible organic solvent or a mixture of such solvents. Preferred water-miscible organic solvents include: C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C-4-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone. Preferably the liquid medium comprises water and 2 or more, especially from 2 to 8, water-soluble organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises a water-immiscible organic solvent, preferably a polar solvent is included because this enhances solubility of the dye in the liquid medium. Examples of polar solvents include C-4-alcohols.

An especially preferred ink comprises:
(a) from 1 to 10 parts in total of a compound of Formula (I) or a composition according to the third aspect of the invention;
(b) from 2 to 60, more preferably 5 to 40 parts of water-soluble organic solvent; and
(c) from 30 to 97, more preferably 40 to 85 parts water;
   wherein all parts are by weight and the sum of the parts (a)+(b)+(c)=100.

The ink may also contain additional components conventionally used in ink jet printing inks, for example viscosity and surface tension modifiers, corrosion inhibitors, biocides, kogation reducing additives, anti-cockle agents to reduce paper curling and surfactants which may be ionic or non-ionic.

The pH of the ink is preferably from 4 to 11 more preferably from 7 to 10.

The viscosity of the ink at 25° C. is preferably less than 50 mPa·s, more preferably less that 20 mPa·s and especially less than 5 mPa·s.

The ink according to the fourth aspect of the present invention preferably has a concentration of halide ions of less than 500 parts per million, more preferably less than 100 parts per million. It is especially preferred that the ink has less than 100, more preferably less than 50 parts per million of divalent and trivalent metals, wherein parts refer to parts by weight relative to the total weight of the ink. Purifying the ink to reduce the concentration of these undesirable ions reduces nozzle blockage in ink jet printing heads, particularly in thermal ink jet printers.

The ink of the present invention preferably forms the yellow ink of a yellow, magenta, cyan and black ink set.

Preferably the ink is as defined in the fourth aspect of the present invention.

The ink jet printer preferably applies the ink to the substrate in the form of droplets which are ejected through a small orifice onto the substrate. Preferred ink jet printers are piezoelectric ink jet printers and thermal ink jet printers. In thermal ink jet printers, programmed pulses of heat are applied to the ink in a reservoir by means of a resistor adjacent to the orifice, thereby causing the ink to be ejected in the form of small droplets directed towards the substrate during relative movement between the substrate and the orifice. In piezoelectric ink jet printers the oscillation of a small crystal causes ejection of the ink from the orifice.

The substrate is preferably paper, plastic, a textile, metal or glass, more preferably a treated substrate such as a coated paper, an overhead projector slide, a textile material or coated plastic, especially plain or treated paper.

A fifth aspect of the present invention provides a substrate (preferably paper, an overhead projector slide or a textile material) printed with an ink comprising a liquid medium and a compound of Formula (1) as defined in the second aspect of the present invention. According to a sixth aspect of the present invention there is provided an ink jet printer cartridge comprising a chamber and ink, wherein the ink is present in the chamber and the ink is as defined in the fourth aspect of the present invention.

According to a seventh aspect of the present invention there is provided an ink jet printer comprising an ink jet printer cartridge, wherein the ink jet printer cartridge is as defined in the sixth aspect of the present invention.

The invention is further illustrated by the following examples in which all parts and percentages are by weight unless otherwise stated.

### EXAMPLE 1

### Preparation of Dye (1)

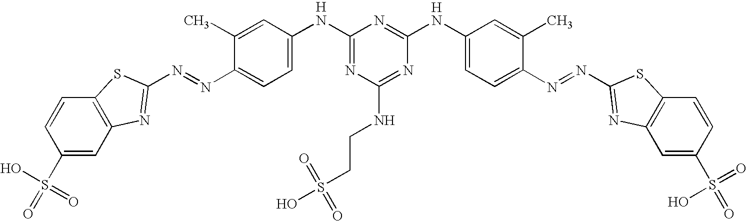

### EXAMPLE 1

Dye (1) may be prepared according to the stages (a) to (c):

### Stage (a):

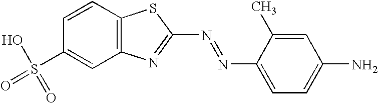

2-Amino-1,3-benzothiazole-5-sulfonic acid (23 g, 0.10 mol) is diazotised in a mixture of acetic acid (200 ml) and propionic acid (20 ml) at 0-5° C. by the drop wise addition of 40% nitrosylsulphuric acid solution (31.8 ml, 0.10 mol). The reaction mixture is stirred at 0-5° C. for 3 hours and then added slowly to a solution of m-toluidine (10.7 g, 0.10 mol) in ethanol (100 ml). The pH of the reaction mixture is adjusted to 4-5 by the addition of sodium acetate and stirred at 0-5° C. for 16 hours. The product is collected by filtration and dried at 60° C.

### Stage (b):

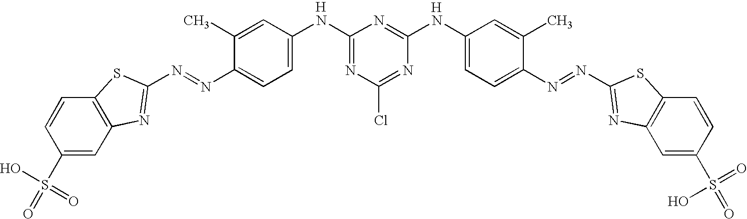

A solution of cyanuric chloride (4.6 g, 0.025 mol) in acetone (100 ml) is added to a mixture of ice/water (300 g). The product from stage (a) (17.4 g, 0.05 mol) is dissolved in water (200 ml) at pH=7 by the addition of 2N sodium carbonate solution and then added to the above described cyanuric chloride suspension at 0-5° C. The pH of the reaction is maintained at 5-6.5 (2N sodium carbonate solution) for 1 hour, the temperature is then allowed to warm to 35-40° C. and the pH adjusted to 7-7.5 by the addition of 2N sodium carbonate solution. The reaction mixture is stirred for 16 hours under these conditions. The product is collected by filtration and used in the next stage without purification.

### Stage (c):

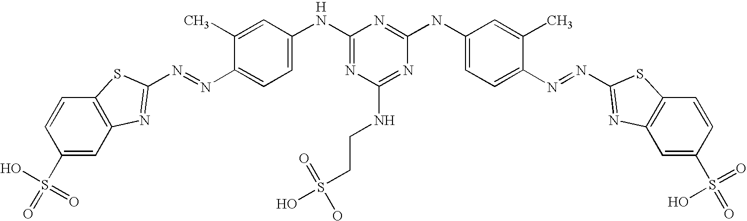

A mixture of the product from stage (b) (8.1 g, 0.01 mol) and taurine (6.3 g, 0.05 mol) in water (300 ml) is stirred at 60-70° C. and pH=9 (2N NaOH) for 8 hours. The reaction mixture is allowed to cool and the crude product collected by filtration. The solid is dissolved in water (500 ml) and purified by dialysis in membrane tubing to low conductivity (<50 μs). Dye (1) is obtained by evaporation at 60° C. to afford an orange solid.

### Inks

The inks described in Tables I and II may be prepared wherein the Dye described in the first column is the Dye (1). Numbers quoted in the second column onwards refer to the number of parts of the relevant ingredient and all parts are by weight. The inks may be applied to paper by thermal or piezo ink jet printing.

The following abbreviations are used in Table I and II:
PG=propylene glycol
DEG=diethylene glycol
NMP=N-methyl pyrollidone
DMK=dimethylketone
IPA=isopropanol
MeOH=methanol
2P=2-pyrollidone
MIBK=methylisobutyl ketone
P12=propane-1,2-diol
BDL=butane-2,3-diol
CET=cetyl ammonium bromide
PHO=Na₂HPO₄
TBT=tertiary butanol
TDG=thiodiglycol

TABLE I

| | Dye | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 1 | 3.0 | 90 | | 5 | 5 | | 0.2 | | | | | |
| 1 | 10.0 | 85 | 3 | | 3 | 3 | | | | 5 | 1 | |
| 1 | 2.1 | 91 | | 8 | | | | | | | | 1 |
| 1 | 3.1 | 86 | 5 | | | | | 0.2 | 4 | | | 5 |
| 1 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 1 | 5 | 65 | | 20 | | | | | 10 | | | |
| 1 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| 1 | 6.0 | 91 | | | 4 | | | | | | 5 | |

TABLE II

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | PI2 |
| 1 | 3.0 | 80 | 15 | | | 0.2 | | | | | 5 | |
| 1 | 9.0 | 90 | | 5 | | | | | | 1.2 | | 5 |
| 1 | 1.5 | 85 | 5 | 5 | | 0.15 | 5.0 | 0.2 | | | | |
| 1 | 2.5 | 90 | | 6 | 4 | | | | | 0.12 | | |
| 1 | 3.1 | 82 | 4 | 8 | | 0.3 | | | | | | 6 |
| 1 | 0.9 | 85 | | 10 | | | | | 5 | 0.2 | | |
| 1 | 8.0 | 90 | | 5 | 5 | | | 0.3 | | | | |
| 1 | 4.0 | 70 | | 10 | 4 | | | | 1 | | 4 | 11 |
| 1 | 2.2 | 75 | 4 | 10 | 3 | | | | 2 | | 6 | |
| 1 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 1 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

### EXAMPLE 2

Inks may be prepared having the formulations described in US Patent Application Publication No. 2005/0076806 except that a compound of Formula (1) as defined in the first aspect of the present invention is used in place of the colorant described therein. Preferred inks of this type are described in Table 1 at pages 9 and 10 of US 2005/0076806. Especially preferred inks of this type are described below in Table III and they may be prepared by mixing the components indicated therein. The inks may be applied to paper by thermal or piezo ink jet printing.

TABLE III

Number of parts (by weight)

| Component | Ink A | Ink B | Ink C | Ink D |
|---|---|---|---|---|
| Dye 1 (from Example 1 | 5 | 5 | 5 | 5 |
| above) | | | | |
| Tripropanolamine | 0.3 | 0.3 | 0.5 | 0.3 |
| Adipic acid | 0.1 | | | 0.082 |
| Succinic acid | | 0.03 | 0.11 | |
| Glycerol | 10 | 10 | 10 | 10 |
| Triethylene glycol | 10 | 10 | 10 | 10 |
| mono n-butyl ether | | | | |
| 2P | 2 | 2 | 2 | 2 |
| Triethylene glycol | 3 | 3 | 2.8 | 2 |
| Surfynol 465 ™ | 1 | 1 | 1 | 1 |
| Water | 68.6 | 68.67 | 68.59 | 69.61 |

Surfynol 465™ is an acetylenic glycol-based surfactant available from Air Products.
2P is 2-pyrollidone.

### EXAMPLE 3

Inks may be prepared having the formulations described above in Table III except that diethylene glycol mono n-butyl ether is used in place of triethylene glycol mono n-butyl ether. Still further inks may be prepared having the formulations described above in Table III except that N-methyl pyrollidone may be used in place of 2-pyrollidone.

### EXAMPLE 4

Inks may be prepared as described in Japanese Patent Application No. 2005-047987 except that a compound of Formula (1) as defined in the first aspect of the present invention is used in place of the colorant used therein. Preferred inks of this type are described in claim 3 and Table 1 (at [0054]) of JP2005-047987. In particular it is preferred that the inks contain 1,2-hexane diol.

### EXAMPLE 5

The black compositions A to D described in Table IV below may be prepared by mixing together the components in the amounts indicated. These black compositions may be used to prepare black ink jet printing inks, for example having an analogous formulation to the inks described in Table III above except that each of the black compositions described in Table IV is used instead of Dye 1 alone.

TABLE IV

| | Number of parts (by weight) | | | |
|---|---|---|---|---|
| | Composi- | Composi- | Composi- | Composi- |
| Component | tion A | tion B | tion C | tion D |
| Dye 1 | 0.8 | 1 | 2 | 0.8 |
| (from Example 1 above) | | | | |
| Black Dye described in | 5 | | | |
| WO 2003/106572, | | | | |
| Example 2 at p13 to 15 | | | | |
| C.I. Direct Black 154 | | 4.5 | | |
| C.I. Direct Black 168 | | | 1.5 | |
| C.I. Direct Black 195 | | | | 4.25 |

### EXAMPLE 6

The yellow compositions E to I described in Table V below may be prepared by mixing together the components indicated. These yellow compositions may be used to prepare ink jet printing inks, for example having an analogous formulation to the inks described in Table III above except that each of the yellow compositions described in Table V is used instead of Dye 1 alone.

TABLE V

| | Number of parts (by weight) | | | | |
|---|---|---|---|---|---|
| | Composition | Composition | Composition | Composition | Composition |
| Component | E | F | G | H | I |
| Dye 1 (from Example | 1.5 | 2 | 2 | 1.9 | 2.1 |
| 1 above) | | | | | |
| C.I. Direct Yellow 86 | 3 | | 1.4 | | |
| C.I. Direct Yellow 88 | | 2.5 | | | |
| C.I. Direct Yellow 132 | | | 1.5 | | |
| C.I. Direct Yellow 173 | | | | 2 | |
| C.I. Acid Yellow 17 | | | | | 0.3 |

### EXAMPLES 7 TO 10

Ink sets may be prepared wherein each ink has the formulation described for Ink A in Table III above, except that in the magenta, cyan and black inks Dye 1 was replaced by the colorant indicated in Table VI below:

TABLE VI

| | Yellow Ink | Magenta Ink | Cyan Ink | Black Ink |
|---|---|---|---|---|
| Example 7 | Ink A | C.I. Acid | C.I. Acid | Pro-Jet ™ |
| | | Red 52 | Blue 9 | Fast Black 2 |
| Example 8 | Ink A | C.I. Direct | C.I. Direct | C.I. Direct |
| | | Red 227 | Blue 199 | Black 168 |
| Example 9 | Ink A | C.I. Acid | C.I. Direct | C.I. Direct |
| | | Red 249 | Blue 86 | Black 168 |
| Example 10 | Ink A | Pro-Jet ™ | C.I. Direct | Cab-O-jet ™ |
| | | Fast Magenta 2 | Blue 199 | 300 |

Cab-O-jet is a trade mark of Cabot corporation.
The ink sets described in Table VI may be incorporated into a thermal ink jet printer and printed onto paper.

1. A process for printing an image on a substrate comprising applying to the substrate by means of an ink jet printer an ink comprising a compound of Formula (1): 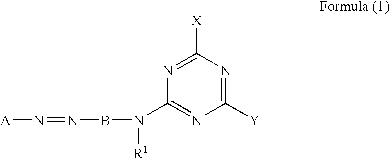
wherein:
one of A and B is an optionally substituted heteroaryl group containing a ring sulphur atom and the other is an optionally substituted aryl or heteroaryl group;
R¹ is H, optionally substituted acyl or optionally substituted alkyl;
X is a hydroxyl, ether, thioether or amine group; and
Y is a hydroxyl, ether, thioether or amine group or a group of the formula —N(R²)-D-N═N-E wherein D and E are each independently optionally substituted aryl or heteroaryl groups and R² is H, optionally substituted acyl or optionally substituted alkyl.

2. (canceled)

3. A process according to claim 1 wherein Y is a group of the formula —N(R²)-D-N═N-E wherein D and E are each independently optionally substituted aryl or heteroaryl groups and R² is H or optionally substituted alkyl.

4. A process according to claim 1 or 3 wherein A is an optionally substituted heteroaryl group containing a ring sulphur atom and B, D and E are each independently optionally substituted aryl or heteroaryl groups.

5. (canceled)

6. A process according to claim 1 or 3 wherein A and E are free from hydroxy groups.

7. A process according to claim 1 or 3 wherein the optionally substituted heteroaryl groups containing a ring sulphur atom are selected from optionally substituted thiophene, benzothiophene, thiazole, benzothiazole, isothiazole, benzoisothiazole, thiadiazole and naphthothiazole groups.

8. A process according to claim 1 or 3 wherein X is an amine group of formula —NR³R⁴ wherein R³ and R⁴ are each independently H, C₁₋₄-alkyl or C₁₋₄-alkyl carrying a hydroxyl, carboxy or sulpho group, or R³ and R⁴ together with the nitrogen atom to which they are attached form an optionally substituted 5- or 6-membered ring.

9. A compound of Formula (1): 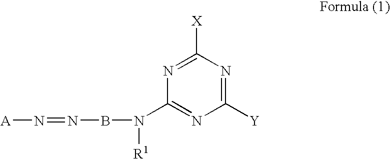
wherein:
one of A and B is an optionally substituted heteroaryl group containing a ring sulphur atom and the other is an optionally substituted aryl or heteroaryl group;
R¹ is H, optionally substituted acyl or optionally substituted alkyl;
X is a hydroxyl, ether, thioether or amine group; and
Y is a hydroxyl, ether, thioether or amine group or a group of the formula —N(R²)-D-N═N-E wherein D and E are each independently optionally substituted aryl or heteroaryl groups and R² is H, optionally substituted acyl or optionally substituted alkyl.

10. A compound according to claim 9 wherein Y is a group of the formula —N(R²)-D-N═N-E wherein D and E are each independently optionally substituted aryl or heretoaryl groups and R² is H or optionally substituted alkyl.

11. An ink for ink jet printing comprising:
(a) a compound of Formula (1) as defined in claim 9; and
(b) a liquid medium.

12. A substrate printed with an ink comprising a liquid medium and a compound of Formula (I) as defined in claim 9.

13. An ink jet printer cartridge comprising a chamber and ink, wherein the ink is present in the chamber and the ink is as defined in claim 11.

14. (canceled)

15. A compound according to claim 9 or 10 wherein X is an amine group of formula —NR³R⁴ wherein R³ and R⁴ are each independently H, C₁₋₄-alkyl or C₁₋₄-alkyl carrying a hydroxyl, carboxy or sulpho group, or R³ and R⁴ together with the nitrogen atom to which they are attached form an optionally substituted 5- or 6-membered ring.

16. A compound according to claim 9 or 10 which is free from carboxy and thiocarboxy groups.
